SEQUENCE LISTING (2 sequences)

SEQ ID NO: 1 - protein, 378 aa, Aspergillus aculeatus
MHLNTTLLVSLALGAASVLASPAPPAITAPPTAEEIAKRATTCTFSGSNGASSASKSKTSCSTIVLSNVAVPSGTTLDLTKLNDGTHVIFSGETTFGYKEWSGPLISVSGSDLTITGASGHSINGDGSRWWDGEGGNGGKTKPKFFAAHSLTNSVISGLKIVNSPVQVFSVAGSDYLTLKDITIDNSDGDDNGGHNTDAFDIGTSTYVTISGATVYNQDDCVAVNSGENIYFSGGYCSGGHGLSIGSVGGRSDNTVKNVTFVDSTIINSDNGVRIKTNIDTTGSVSDVTYKDITLTSIAKYGIVVQQNYGDTSSTPTTGVPITDFVLDNVHGSVVSSGTNILISCGSGSCSDWTWTDVSVSGGKTSSKCTNVPSGASC

SEQ ID NO: 2 - protein, 331 aa, Aspergillus aculeatus
MVKSVLASALFAVSALAASRTTAPSGAIVVAKSGGDYTTIGDAIDALSTSTTDTQTIFIEEGTYDEQVYLPAMTGKVIIYGQTENTDSYADNLVTITHAISYEDAGESDDLTATFRNKAVGSQVYNLNIANTCGQACHQALALSAWADQQGYYGCNFTGYQDTLLAQTGNQLYINSYIEGAVDFIFGQHARAWFQNVDIRVVEGPTSASITANGRSSETDTSYYVINKSTVAAKEGDDVAEGTYYLGRPWSEYARVVFQQTSMTNVINSLGWTEWSTSTPNTEYVTFGEYANTGAGSEGTRASFAEKLDAKLTITDILGSDYTSWVDTSYF

(19) United States
(12) Patent Application Publication
(10) Pub. No.: US 2012/0328736 A1
(43) Pub. Date: Dec. 27, 2012

(54) Enzymatic Pretreatment For Making Dried Fruits

(75) Inventors: Mingguang Han, Beijing (CN); Juan Zhao, Beijing (CN); Aihua Yan, Beijing (CN); Guigang Wu, Beijing (CN)

(73) Assignee: NOVOZYMES A/S, Bagsvaerd (DK)

(21) Appl. No.: 13/521,301

(22) PCT Filed: Feb. 25, 2011
(86) PCT No.: PCT/CN11/71301

§ 371 Date: Jul. 19, 2012

(30) Foreign Application Priority Data
Feb. 26, 2010 (CN) PCT/CN2010/070763

(51) Int. Cl. A23B 7/022; A23B 7/155

(52) U.S. Cl. 426/50; 426/52

(57) ABSTRACT

A process for dried fruit preparation, which process comprises treating fruit with polygalacturonase before drying step. Polygalacturonase can be further used in combination with pectinesterase, pectin lyase, pectate lyase, xyloglucanase, beta-glucanase, amylase and lipase.

### REFERENCE TO A SEQUENCE LISTING

This application contains a Sequence Listing in computer readable form. The computer readable form is incorporated herein by reference.

### FIELD OF THE INVENTION

The present invention relates to a process for making dried fruit, comprising contacting the fruit with polygalacturonases before drying step.

### BACKGROUND OF THE INVENTION

There are three main operations in the conversion of grape to raisin: pretreatment, drying, and post drying operations (Food Reviews International, 23:257-280, 2007).

The purpose of the pretreatment is to increase the permeability of the grape skin to moisture. The skin, based on the hydrophobic nature of the wax layer, serves as a protective barrier. The low moisture diffusivity due to this hydrophobic molecular barrier in the cuticular wax of the berry skin may lead to a time-consuming drying process. The chemical pretreatment on the grape drying process has been addressed in the literature. The pretreatment with the application of an oil emulsion or a dilute alkaline solution is a common practice to accelerate the drying process by reducing the resistance to moisture transfer of the surface skin of grapes and by improving the internal moisture diffusion coefficient. The dilute alkaline solution commonly used includes potassium carbonate solution and sodium hydroxide solution etc. (Journal of Food Engineering 39 (1999) 211-216).

Grape drying process varies in different parts of the world, depending on the cultivation conditions. There are three main methods that are used for fruit drying: sun drying, shade drying, and mechanical drying. The sun drying method has several disadvantages including, the possibility of environmental contamination due to dust and insect infections, physical microbial deterioration caused by rain, and color deterioration due to intense solar radiation. Mechanical drying which is safe, rapid, and controllable is attractive to dry fruit production, especially when high throughput is needed.

Following production of dried grapes, either by sun drying or other drying techniques, they must be delivered to an appropriate processing unit. The post-drying operations may vary depending on the drying method. Generally, during post-drying operations, raisins are washed in order to get rid of dust on the dry fruit surface and small peduncle; after the wash, raisins are spin dried to get rid of water; then raisins are cleaned which involves individualizing the dried fruit, removal of stems and foreign materials, and removal of off-grade raisins; and finally, food grade oil and chemicals are applied to make the raisins looks nicer and keep microbial away. After post drying operation, the raisins are ready for packaging.

JP2004057157 describes that after post-drying operation, the dried fruits are undergone enzymatic treatment, which gives a modification in the taste.

To date, most researchers have concentrated on the pretreatment and drying, in order to optimize the dried fruit production process to make the operation more energy saving and environmentally friendly.

### SUMMARY OF THE INVENTION

It is an object of the present invention to provide an enzymatic process for the dried fruit preparation, which process comprises treating fruit with polygalacturonases during pretreatment process.

In particular embodiment of the present invention, the process comprises treating fruit with a combination of polygalacturonase and at least one of the enzymes selected from the group consisting of pectinesterase, pectin lyase, pectate lyase, xyloglucanase, beta-glucanase, amylase and lipase.

In a particular embodiment of the present invention, the process comprises treating the fruit with a combination of polygalacturonase and pectinesterase.

In another particular embodiment, the enzymatic treatment of the present invention is followed by the drying step.

Specifically, the present invention is used to produce raisin. The present invention can be applied to fruits such as grape, cherry tomato, plum, apricot, cranberry, blueberry and cherry etc. to produce dried fruit thereof, as the mechanism and process of making dried fruits are similar.

The present invention can be carried out under nearly neutral pH, which means a more environmental friendly process by reducing effluent load. The fruit treated by the present invention may even achieve an optimal result of dehydration in a relatively short period of time in the subsequent drying step, which will save energy.

### DETAILED DESCRIPTION OF THE INVENTION

### Grape Skin Structure

The skin of the grape, which plays a critical role in controlling the drying process, consists of an epidermis and six to ten layers of small thick-walled cells. The number of layers in the skin of grape berries, their size, and volume are cultivar specific issues. The grape of different origins might vary a lot in the number of layers in the skin. The outer epidermis is covered by non-living layers, namely cuticle, lenticels, wax, and collenchymatous hypodermal cells. The skin, based on the hydrophobic nature of the wax layer, serves as a protective barrier against fungal pathogens. It further reduces the water loss due to transpiration and protects the grape from UV light and physical injuries. The skin also controls gaseous exchanges between the berry and the surrounding environment.

The wax is made up of both an amorphous layer, consisting of a series of overlapping hydrophobic platelets and intracuticular wax that is present in the structure of the outer epidermis. The amorphous layer allows water to be transferred only in the vapor form. Although, the presence of waxes in the skin cuticle is an obstacle to drying, it is important to mention that their removal by chemical treatment which increases the drying rate, requires special attention because of their strong effect on the shelf life and safety of the dried products.

### Pretreatment Process for Making Dried Fruits

The effects of chemical pretreatment on the grape drying process have been addressed to some extent in the literature. The pretreatment with application of an oil emulsion or an alkaline solution is a common practice to accelerate the drying process by reducing the resistance to moisture transfer of the surface skin of grapes and by improving the internal moisture diffusion coefficient. The alkaline solution commonly used for pretreatment includes potassium carbonate solution and sodium hydroxide solution etc, generally at pH value over 11.

The pretreatments will cause an increase in the drying rate particularly at the early stage of the drying process. The composition, concentration, pH and temperature of the chemicals and the pretreatment time are effective factors in micro-structural changes of the skin layers. The physical and chemical phenomena involved in the pretreatment process can later affect the grape drying parameters. Thus, the control of the pretreatment and drying conditions is necessary in order to produce a product that can be easily and safely processed after drying practice.

The present inventors surprisingly found that that polygalacturonase can be used in pretreatment step for preparing dried fruit, if desired in combination with at least one enzyme including but not limited to pectinesterase, pectin lyase, pectate lyase, xyloglucanase, beta-glucanase, amylase and/or lipase.

In a particular embodiment of the present invention, the process comprises treating fruit with a combination of polygalacturonase and pectinesterase.

The enzymatic pretreatment of the present invention may be followed by drying step. According to the industrial needs, the final weight loss reaches around 70% or even higher after drying step.

Further, the drying step may be followed by post drying operations to clean the raisin and/or apply food grade oil and chemicals.

The enzymatic pretreatment process of the present invention may be carried out at temperature above 10° C., 15° C. or 20° C. A typical temperature is in the range of 10 to 80° C., 10 to 70° C., 10 to 60° C., 15 to 50° C., 30 to 50° C., 15 to 40° C., 20 to 40° C., 15 to 30° C. or 20 to 30° C. More preferably, it is carried out at room temperature.

The enzymatic pretreatment process of the present invention may be preferably carried out at a pH in the range of 4 to 8, 4 to 7, or 5 to 7, more preferably under a pH close to neutral, such as pH 5.5 to 7, 5.5 to 6.5, or 6 to 7. Treatment conducted at pH close to neutral is of great industrial value, which leads to simpler process to handle the waste solution after the pretreatment step.

The reaction time of the present invention shall be no less than 3 minutes, preferably no less than 5 minutes, more preferably no less than 10 minutes, and even more preferably no less than 15 minutes. A suitable duration of the enzymatic treatment of the present invention may be from a few minutes to several hours, e.g. from about 3 minutes to about 48 hours, or from about 5 minutes to about 24 hours, or from about 5 minutes to about 12 hours, or from about 5 minutes to 5 hours, preferably from about 5 minutes to about 1 hour, more preferably from about 5 minutes to about 30 minutes, more preferably from about 10 minutes to about 30 minutes, even more preferably about 15 minutes to about 1 hour, and most preferably about 20 minute to about 1 hours.

The enzyme of the invention should be added in an effective amount. By the term “effective amount” is meant the amount sufficient to generate enhanced drying effect as compared to the alkaline chemical pretreatment. It should be appreciated that the “effective amount” will be dependent on various parameters including: the concentration of the aqueous enzyme solution, the pH of the solution, the duration the solution is applied, the temperature of the solution and the type of grape, for example the thickness of the skin, the size of the grape volume, and other characteristics of the fruits. The dosage used in the invention may be determined on the basis of methods known in the art.

In particular embodiments, the amount of enzyme used in the present invention is no less than 0.5‰ on fruit to be treated (calculated as enzyme protein on the weight of fruit, i.e. 0.5 gram enzyme protein per kilogram of fruit), more preferably, above 1‰, or above 2‰ on weight of fruit. In further particular embodiments, the amount of enzyme is in the range of 0.5‰ to 5%, 0.2‰ to 5%, 0.5‰ to 1%, 1‰ to 1%, 2‰ to 1%, 4‰ to 2%, or 4‰ to 1% on weight of fruit. These amounts refer to the amount of each enzymes indicated below.

### Enzymes

### Polygalacturonase (PG)

Polygalacturonase (EC 3.2.1.15) catalyzes the random hydrolysis of 1,4-alpha-D-galactosiduronic linkages in pectate and other galacturonans. Examples of other names are: Pectin depolymerase; pectinase; endopolygalacturonase; endo-polygalacturonase; and endo-galacturonase. The systematic name is poly(1,4-alpha-D-galacturonide) glycanohydrolase.

The source of the enzymes is not critical for use in the methods of the present invention. Accordingly, the enzymes may be obtained from any source such as a plant, microorganism, or animal. The enzymes are preferably obtained from a microbial source, such as a bacterium or a fungus, e.g., a filamentous fungus or yeast and may be obtained by techniques conventionally used in the art.

In a preferred embodiment, the enzymes are obtained from a fungal source. For example, the enzymes may be obtained from a yeast strain such as a Candida, Kluyveromyces, Pichia, Saccharomyces, Schizosaccharomyces, or Yarrowia strain; or from a filamentous fungal strain such as an Acremonium, Aspergillus, Aureobasidium, Chrysosporium, Cryptococcus, Filibasidium, Fusarium, Humicola, Magnaporthe, Monilia, Mucor, Myceliophthora, Neocallimastix, Neurospora, Paecilomyces, Penicillium, Phanerochaete, Piromyces, Schizophyllum, Sclerotium, Sporotrichum, Talaromyces, Thermoascus, Thielavia, Tolypocladium, or Trichoderma strain.

In a particular embodiment, the polygalacturonase for use according to the invention is derived from Aspergillus, especially from Aspergillus aculeatus. Preferably, it is polygalacturonase I, II or III as obtained according to U.S. Pat. No. 6,159,718. More preferably the polygalacturonase has amino acid sequence that has a degree of identity to the mature polypeptide of SEQ ID NO: 1 in the present invention of at least 70%, at least 75%, at least 80%, at least 85%, at least 90%, at least 91%, at least 92%, at least 93%, at least 94%, or at least 95%, at least 96%, at least 97%, at least 98%, at least 99%, or at least 100% (hereinafter “homologous polypeptides”).

In a preferred aspect, the homologous polypeptides have a substitution, deletion, and/or insertion of one or more (or several) amino acids of the mature polypeptide of SEQ ID NO: 1. More preferably, the polygalacturonase has a substitution, deletion, and/or insertion of at least 10, 9, 8, 7, 6, 5, 4, 3, 2 or 1 amino acids of the mature polypeptides of SEQ ID NO: 1.

The parameter “identity” as used in the present invention describes the relatedness between two amino acid sequences. For purposes of the present invention, the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277; http://emboss.org), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

For purposes of the present invention, the degree of identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra; http://emboss.org), preferably version 3.0.0 or later. The optional parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment)

Substantially homologous polypeptides of the sequences described in the present context are characterized as having one or more (several) amino acid substitutions, deletions, and/or insertions in the mature polypeptide. Preferably, amino acid changes are of a minor nature, that is conservative amino acid substitutions or insertions that do not significantly affect the folding and/or activity of the protein; small deletions, typically of one to about 9 amino acids, preferably from one to about 15 amino acids and most preferably from one to about 30 amino acids; small amino- or carboxyl-terminal extensions, such as an amino-terminal methionine residue; a small linker peptide of up to about five to ten residues, preferably from 10 to 15 residues and most preferably from 20 to 25 residues, or a small extension that facilitates purification by changing net charge or another function, such as a poly-histidine tag, an antigenic epitope, protein A, a CBM or an another binding domain.

Examples of conservative substitutions are within the group of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. The most commonly occurring exchanges are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/Ile, Leu/Val, Ala/Glu, and Asp/Gly.

Essential amino acids in a parent polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for enzyme activity to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labeling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identities of essential amino acids can also be inferred from analysis of identities with polypeptides that are related to the parent polypeptide.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochem. 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide of interest, and can be applied to polypeptides of unknown structure.

In a particular embodiment, the amount of polygalacturonase used in the present invention is no less than 0.5‰ on fruit to be treated (calculated as enzyme protein on the weight of fruit), more preferably, above 1‰, or above 2‰ on fruit. In further particular embodiments, the amount of enzyme is in the range of 0.5‰ to 5%, 0.2‰ to 5%, 0.5‰ to 1%, 1‰ to 1%, 2‰ to 1%, 4‰ to 2%, or 4‰ to 1% on weight of fruit.

### Pectinesterase (PE)

Pectinesterase (EC 3.1.1.11) catalyzes the reaction: pectin+n H₂O=n methanol+pectate. Examples of other names are: Pectin demethoxylase; pectin methylesterase; and pectin methyl esterase. The systematic name is pectin pectylhydrolase.

Pectinesterases derived from Aspergillus aculeatus and Meripilus giganteus are described in WO94/25575 and WO97/31102, respectively.

In a particular embodiment, the pectinesterases for use according to the invention has amino acid sequence that has a degree of identity to the mature polypeptide of SEQ ID NO: 2 in the present invention of at least 70%, at least 75%, at least 80%, at least 85%, at least 90%, at least 91%, at least 92%, at least 93%, at least 94%, or at least 95%, at least 96%, at least 97%, at least 98%, at least 99%, or at least 100% (hereinafter “homologous polypeptides”).

In a preferred aspect, the homologous polypeptides have a substitution, deletion, and/or insertion of one or more (or several) amino acids of the mature polypeptide of SEQ ID NO: 2. More preferably, the pectinesterases has a substitution, deletion, and/or insertion of at least 10, 9, 8, 7, 6, 5, 4, 3, 2 or 1 amino acids of the mature polypeptides of SEQ ID NO: 2.

In a particular embodiment, the amount of pectinesterases used in the present invention is no less than 0.5‰ on fruit to be treated (calculated as enzyme protein on the weight of fruit), more preferably, above 1‰, or above 2‰ on fruit. In further particular embodiments, the amount of enzyme is in the range of 0.5‰ to 5%, 0.2‰ to 5%, 0.5‰ to 1%, 1‰ to 1%, 2‰ to 1%, 4‰ to 2%, or 4‰ to 1% on weight of fruit.

### Pectate Lyase

Pectate lyase (EC 4.2.2.2) catalyzes the eliminative cleavage of (1,4)-alpha-D-galacturonan to give oligosaccharides with 4-deoxy-alpha-D-galact-4-enuronosyl groups at their non-reducing ends. Examples of other names are: pectate transeliminase; polygalacturonic transeliminase; and endopectin methyltranseliminase. The systematic name is (1,4)-alpha-D-galacturonan lyase. In a particular embodiment, the pectate lyase for use according to the invention is derived from Bacillus.

### Pectin Lyase

Pectin lyase (EC 4.2.2.10) catalyses eliminative cleavage of (1,4)-alpha-D-galacturonan methyl ester to give oligosaccharides with 4-deoxy-6-O-methyl-alpha-D-galact-4-enuronosyl groups at their non-reducing ends. Pectin lyase may be known under the names: pectin transeliminase; endo-pectin lyase; polymethylgalacturonic transeliminase; pectin methyltranseliminase; pectolyase.

According to the invention a microbial pectin lyase is preferred. The microbial pectin lyase may be derived from bacteria or fungi (including filamentous fungi and yeasts). The microbial pectin lyase is preferably obtained from a fungus. The fungus may be a strain belonging to the subdivision Basidiomycotina or to the subdivision Ascomycotina. Suitable examples include pectin lyases derivable from strains of Aspergillus sp. A pectin lyase derived from Aspergillus aculeatus is described in WO 94/21786.

Pectin lyases derivable from strains within A. niger or A. oryza are preferred. Commercial pectin lyase compositions suitable for the present invention are CITROZYM PREMIUM, PECTINEX SMASH XXL, NOVOFERM P and NOVOFERM A available from Novozymes A/S.

### Lipase

Suitable lipases include those of bacterial or fungal origin. Chemically or genetically modified mutants are included. The lipase may for example be triacylglycerol lipase (EC3.1.1.3), phospholipase A2 (EC 3.1.1.4), Lysophospholipase (EC 3.1.1.5), Monoglyceride lipase (EC 3.1.1.23), galactolipase (EC 3.1.1.26), phospholipase A1 (EC 3.1.1.32), Lipoprotein lipase (EC 3.1.1.34).

Examples of useful lipases include a Humicola lanuginosa lipase, e.g., as described in EP 258 068 and EP 305 216, a Rhizomucor miehei lipase, e.g., as described in EP 238 023. Other types of lipolytic enzymes such as cutinases may also be useful, e.g., a cutinase derived from Pseudomonas mendocina as described in WO 88/09367, or a cutinase derived from Fusarium solani pisi (e.g. described in WO 90/09446).

Especially suitable lipases are lipases such as M1 Lipase™, Luma Fast™ and Lipomax™ (Genencor), Lipolase™ and Lipolase Ultra™ (available from Novozymes A/S), and Lipase P “Amano” (Amano Pharmaceutical Co. Ltd.).

### Amylase

Suitable amylases for use include e.g., alpha-amylases (EC 3.2.1.1), beta-amylases (EC 3.2.1.2) and/or glucoamylases (EC 3.2.1.3) of bacterial or fungal origin. Chemically or genetically modified mutants are included. Amylases include, for example, alpha-amylases obtained from a special strain of B. licheniformis, described in more detail in GB 1,296,839. Relevant commercially available amylases include Natalase®, Stainzyme®, Duramyl®, Termamyl®, Termamyl™ Ultra, Fungamyl® and BAN® (all available from Novozymes A/S, Bagsvaerd, Denmark), and Rapidase® and Maxamyl® P (available from DSM, Holland) and Purastar®, Purastar OxAm and Powerase™ (available from Danisco A/S).

### Xyloglucanase

According to the present invention, a xyloglucanase is defined as any enzyme which has an activity towards the substrate xyloglucan, capable of catalyzing the solubilisation of xyloglucan to xyloglucan oligosaccharides.

Preferably the xyloglucanase according to the invention is produced by micro-organisms such as fungi or bacteria. Examples of useful xyloglucanases are family 12 xyloglucan hydrolyzing endoglucanases. Another useful example is a xyloglucanase produced by Trichoderma, especially EGIII. The xyloglucanase may also be an endoglucanase with xyloglucanase activity and low activity towards insoluble cellulose and high activity towards soluble cellulose, e.g., family 7 endoglucanases obtained from, e.g., Humicola insoles.

### EXAMPLES

### Materials and Reagents

Grape: Chinese origin of green grape, Chinese origin of purple grape (Purchased from supermarket in Beijing, China)

### Chemical: Na₂HPO₄.12H₂O, C₆H₈O₇.H₂O

Citrate buffer (pH4.0, 50 mM): 9.964 g Na₂HPO₄.12H₂O and 4.656 g of C₆H₈O₇.H₂O were dissolved in 1 L of de-ionized water.
Citrate buffer (pH5.5, 50 mM): 9.964 g Na₂HPO₄.12H₂O and 4.656 g of C₆H₈O₇.H₂O were dissolved in 1 L of de-ionized water (pH value adjusted to 5.5 with 0.1 mol/L NaOH solution).
Citrate buffer (pH6.5, 50 mM): 9.964 g Na₂HPO₄.12H₂O and 4.656 g of C₆H₈O₇.H₂O were dissolved in 1 L of de-ionized water (pH value adjusted to 6.5 with 0.1 mol/L NaOH solution).
Polygalacturonase (PG): Aspergillus aculeatus polygalacturonase shown as mature peptide of amino acids 40-378 of SEQ ID NO:1 in the present invention (obtained according to U.S. Pat. No. 6,159,718)
Pectinesterase (PE): Aspergillus aculeatus pectinesterase shown as mature peptide of amino acids 18-331 of SEQ ID NO:2 in the present invention (UNIPROT:Q12535, described in “Pectin methyl esterase from Aspergillus aculeatus: expression cloning in yeast and characterization of the recombinant enzyme”; Biochem. J. 319:705-712 (1996))

### Weight Loss Determination

Grapes were weighted by the analystic balance and recorded. After enzymatic treatment, the grapes were dried and weighted again. The weight loss is defined as: (weight before treatment−weight after treatment)/weight before treatment.

### Example 1

### Pretreatment of Grapes with Polygalacturonase

100 g grapes (Chinese origin of green grape) were added into the following five beakers.

Group 1: 100 g grapes were added into 200 ml NaOH solution with NaOH concentration of 15 g/l, with pH value of the solution being 13.0.

Group 2: 100 g grapes were added into 200 ml citrate buffer (pH4.0, 50 mM).

Group 3: 200 ml stock solution of citrate buffer (pH4.0, 50 mM) with low PG concentration of 0.2% (w/w) was prepared. 100 g grapes were added into the solution.

Group 4: 200 ml stock solution of citrate buffer (pH4.0, 50 mM) with high PG concentration of 0.4% (w/w) was prepared. 100 g grapes were added into the solution.

The grapes in group 2, 3 and 4 were immersed at 50° C. for 30 minutes. The grapes in group 1 were immersed at room temperature for 30 second, as the industrial process of raisin production. Then all grapes were taken out of the beakers, dried in the oven at 45° C., and weighted at intervals of several hours to determine the weight loss. Results of weight loss were given in Table 1.

TABLE 1
Weight loss in the drying process

| | Weight loss | | | | | | |
|---|---|---|---|---|---|---|---|
| | weight | weight | weight | weight | weight | weight | weight |
| | loss at | loss at | loss at | loss at | loss at | loss at | at loss |
| Sample treated by | 2 hours | 4 hours | 6 hours | 8 hours | 10 hours | 22 hours | 26 hours |
| Group 1 (NaOH) | 2.0% | 4.5% | 6.9% | 9.3% | 11.1% | 22.6% | 27.8% |
| Group 2 | 9.4% | 16.8% | 22.3% | 27.1% | 31.5% | 50.7% | 55.6% |
| Group 3 (PG 0.2%) | 18.0% | 27.4% | 34.8% | 40.8% | 45.7% | 65.6% | 69.5% |
| Group 4 (PG 0.4%) | 13.3% | 23.8% | 31.3% | 38.4% | 44.1% | 65.2% | 69.2% |

For the samples treated by polygalacturonase, the weight loss reached 27.4% and 23.8% after drying for 4 hours, while it took at least 22 hours to reach the same level of weight loss for NaOH treated grape. At 26 hours, the samples treated by polygalacturonase reached the weight loss of nearly 70%, which meets the industrial standard of weight loss for raisin production, while the weight loss of the samples treated by NaOH was only 27.8%.

These results show that the addition of polygalacturonase can be a method to substitute the traditional method of grape pretreatment with NaOH, while at the same time speeds the drying process.

### Example 2

### Pretreatment of Grapes with Polygalacturonase at Different pH and Temperature

100 g grapes (Chinese origin of purple grape) were added into the following four beakers.

Group 1: 100 g grapes were added into 200 ml NaOH solution with concentration of 15 g/l.

Group 2: 200 ml stock solution of citrate buffer (pH4.0, 50 mM) with PG concentration of 0.2% (w/w) was prepared. 100 g grapes were added into the solution.

Group 3: 200 ml stock solution of citrate buffer (pH5.5, 50 mM) with PG concentration of 0.2% (w/w) was prepared. 100 g grapes were added into the solution.

Group 4: 200 ml stock solution of citrate buffer (pH6.5, 50 mM) with PG concentration of 0.2% (w/w) was prepared. 100 g grapes were added into the solution.

The grapes in group 2 were immersed at 30° C. for 30 minutes. The grapes in group 3 and 4 were immersed at 50° C. for 30 minutes. The grapes in group 1 were immersed at room temperature for 30 second, as the industrial process of raisin production. Then all grapes were taken out of the beakers, dried in the oven at 45° C., and weighted at intervals of several hours to determine the weight loss. Results were given in Table 2.

TABLE 2
Weight loss in the drying process

| | Weight | weight | weight | weight | weight | weight | weight | weight | weight |
|---|---|---|---|---|---|---|---|---|---|
| Sample | loss at | loss at | loss at | loss at | loss at | loss at | loss at | loss at | loss at |
| treated by | 2 hours | 4 hours | 8 hours | 10 hours | 22 hours | 30 hours | 48 hours | 120 hours | 168 hours |
| NaOH | 1.6% | 3.1% | 6.1% | 12.5% | 16.1% | 18.9% | 28.2% | 60.0% | 76.5% |
| PG at 30° C., | 1.8% | 3.6% | 7.5% | 14.9% | 18.5% | 22.0% | 31.4% | 62.8% | 78.3% |
| pH4.0 | | | | | | | | | |
| PG at 50° C., | 3.0% | 3.7% | 7.0% | 14.2% | 18.2% | 21.4% | 31.5% | 61.8% | 76.2% |
| pH5.5 | | | | | | | | | |
| PG at 50° C., | 2.0% | 3.7% | 6.9% | 13.9% | 17.6% | 20.5% | 30.4% | 63.5% | 79.5% |
| pH6.5 | | | | | | | | | |

The skin of grapes in Example 2 was thicker than that in Example 1, therefore it took longer time to dry. Compared with grapes treated by NaOH, the grapes treated by enzyme under different conditions showed slight improvement on drying efficiency. The appearance of the grapes showed no obvious difference between NaOH treated group and enzyme treated groups. These results show that enzymatic treatment on grapes under various conditions can be an effective method for grape pretreatment, and the pretreatment performs quite well under nearly neutral pH such as pH5.5 or pH 6.5.

### Example 3

### Pretreatment of Grapes with Polygalacturonase and Pectinesterase

100 g grapes (Chinese origin of purple grape) were added into the following two beakers.

Group 1: 100 g grapes were added into 200 ml NaOH solution with concentration of 15 g/l.

Group 2: 200 ml stock solution of citrate buffer (pH4.0, 50 mM) with PG concentration of 0.15% (w/w) and PE concentration of 0.05% (w/w) was prepared. 100 g grapes were added into the solution.

The grapes in group 2 were immersed at 50° C. for 30 minutes. The grapes in group 1 were immersed at room temperature for 30 second, as the industrial process of raisin production. Then all grapes were taken out of the beakers, dried in the oven at 45° C., and weighted at intervals of several hours to determine the weight loss. Results were given in Table 3.

TABLE 3
Weight loss in the drying process

| | | | | | Weight | Weight | Weight | Weight | Weight | Weight |
|---|---|---|---|---|---|---|---|---|---|---|
| | Weight | Weight | Weight | Weight | loss at | loss at | loss at | loss at | loss at | loss at |
| Sample | loss at 2 | loss at 4 | loss at 6 | loss at 8 | 10 | 22 | 30 | 48 | 120 | 168 |
| treated by | hours | hours | hours | hours | hours | hours | hours | hours | hours | hours |
| NaOH | 1.6% | 3.1% | 4.6% | 6.1% | 12.5% | 16.1% | 18.9% | 28.2% | 60.0% | 76.5% |
| PG and PE | 3.8% | 6.8% | 9.6% | 12.2% | 23.2% | 28.3% | 32.3% | 43.5% | 72.8% | 82.8% |

For the grapes treated by polygalacturonase and pectinesterase enzyme mixture, the water loss after drying 22 hours was 28.3%, while it took about 48 hours for grapes treated by NaOH to reach the same level. At 120 hours, the samples treated by enzymes reached the weight loss of nearly 70%, which meets the industrial standard of weight loss for raisin production, while in contrast, it took about 168 hours for grapes treated by NaOH to reach the same level.

These results show that the addition of that polygalacturonase and pectinesterase can be an effective method for grape pretreatment, which can even speed the drying process, contributing to improvement of drying efficiency and energy saving.

1-15. (canceled)

16. A process for dried fruit preparation, which process comprises treating fruit with polygalacturonase.

17. The process of claim 16, wherein the process comprises treating fruit with polygalacturonase and at least one of the enzymes selected from the group consisting of pectinesterase, pectin lyase, pectate lyase, xyloglucanase, beta-glucanase, amylase and lipase.

18. The process of claim 16, wherein the process comprises treating fruit with polygalacturonase and pectinesterase.

19. The process of claim 16, wherein the enzymatic treatment is followed by a drying step.

20. The process of claim 16, wherein the polygalacturonase is derived from a strain of Aspergillus.

21. The process of claim 16, wherein the treatment is carried out at a temperature above 10° C.

22. The process of claim 16, wherein the treatment is carried out at a temperature above 15° C.

23. The process of claim 16, wherein the treatment is carried out at a temperature above 20° C.

24. The process of claim 21, wherein the treatment is carried out at a temperature in the range of 10 to 80° C.

25. The process of claim 21, wherein the treatment is carried out at a temperature in the range of 10 to 70° C.

26. The process of claim 16, wherein the treatment is carried out at a pH in the range of 4 to 8.

27. The process of claim 26, wherein the treatment is carried out at a pH in the range of 6 to 7.

28. The process of claim 16, wherein the treatment is carried out at a reaction time of no less than 3 minutes.

29. The process of claim 28, wherein the treatment is carried out at a reaction time in the range of 3 minutes to 48 hours.

30. The process of claim 16, wherein the treatment is carried out at an enzyme dosage of no less than 0.5‰ on weight of fruit.

31. The process of claim 30, wherein the treatment is carried out at an enzyme dosage in the range of 0.5‰ to 5% on weight of fruit.

32. The process of claim 16, wherein the fruit is selected from the group consisting of grape, cherry tomato, plum, apricot, cranberry, blueberry and cherry.

33. The process of claim 32, wherein the fruit is grape.
